(19) United States
(12) Patent Application Publication
(10) Pub. No.: US 2025/0246660 A1
(43) Pub. Date: Jul. 31, 2025

(54) STABLE ION EXCHANGE MEMBRANES WITH RADICAL SAVENGER

(71) Applicant: THE CHEMOURS COMPANY FC, LLC, WILMINGTON, DE (US)

(72) Inventors: ANDREW M. PARK, WILMINGTON, DE (US); SAMUEL BARTUSKA, NEWARK, DE (US); GEORGE W. BROWN, BEAR, DE (US); RYAN GEBHARDT, SWEDESBORO, NJ (US); BENJAMIN MICHAEL STRATTON WRIGHT, PERRYVILLE, MD (US)

(73) Assignee: THE CHEMOURS COMPANY FC, LLC, WILMINGTON, DE (US)

(21) Appl. No.: 18/700,116

(22) PCT Filed: Oct. 11, 2022
(86) PCT No.: PCT/US2022/046209

§ 371 Date: Apr. 10, 2024

Related U.S. Application Data
(60) Provisional application No. 63/254,307, filed on Oct. 11, 2021.
(60) Provisional application No. 63/352,039, filed on Jun. 14, 2022.

(51) Int. Cl. H01M 8/1051; C25B 13/07; C25B 13/08; H01M 8/1004; H01M 8/1023; H01M 8/1039; H01M 8/1053; H01M 8/1067

(52) U.S. Cl. CPC H01M 8/1051; H01M 8/1004; H01M 8/1023; H01M 8/1039; H01M 8/1053; H01M 8/1067; C25B 13/07; C25B 13/08

(57) ABSTRACT

Described is a long-lasting, heavy-duty ion exchange membrane comprising a fluorinated ionomer, a CeₓM₁₋ₓO_{y} nanoparticle, and optional additives; where x is 0.2-0.9, y is 1-3, and M is Zr, Gd, Pr, Eu, Nd, La, Hf, Tb, Pd, Pt, or Ni. Optional additives may include reinforcement layers, which may be embedded in the ion exchange membrane. Such membranes are formed from ion exchange polymer dispersions and are useful to form membrane assemblies for fuel cell or water electrolysis applications. The present membranes and membrane assemblies have improved chemical stability and durability in such applications.

### CROSS REFERENCE TO RELATED APPLICATIONS

This application is a national filing under 35 U.S.C. 371 of International Application No. PCT/US2022/046209 filed Oct. 11, 2022 and claims the benefit of priority of U.S. Provisional Application No. 63/254,307 filed Oct. 11, 2021 and U.S. Provisional Application No. 63/352,039 filed Jun. 14, 2022, the disclosures of which are incorporated herein by reference in their entirety.

### FIELD OF THE INVENTION

Ion exchange dispersions and membranes have a CeₓM₁₋ₓO_{y} compound incorporated directly into the composition to improve the chemical stability and durability of membranes in fuel cell or water electrolysis applications.

### BACKGROUND OF THE INVENTION

Polymer electrolyte membranes in fuel cell, water electrolyzer, or other applications are subject to chemical stressors that cause membrane thinning and premature failure. Reaction and ion transport in the fuel cell or water electrolyzer occur in an ion exchange membrane, such as one made from perfluorinated sulfonic acid ionomer, and across a membrane electrode assembly which includes an anode and a cathode. In a fuel cell, hydrogen ions, generated by an electrochemical reaction of hydrogen introduced into the anode, migrate to the cathode as a reduction electrode through the membrane and electrons migrate to the cathode through an external circuit creating electricity. In the cathode, oxygen molecules, hydrogen ions, and electrons react with each other to generate heat and water. In a water electrolyzer, protons—driven by an oxygen-evolving electrochemical reaction of water introduced into the anode—migrate to the cathode as a reduction electrode through the membrane and electrons migrate to the cathode through an external circuit. In the cathode, hydrogen gas is evolved from the combination of protons and electrons. However, during the ion exchange process in either application, hydrogen peroxide and peroxide radicals may also form, which can attack and degrade the membrane polymer.

One solution previously used is adding cerium compounds, such as cerium oxide, cerium (III) hexahydrate, into the membrane to scavenge radical species that initiate the degradation. Other relevant references, such as U.S. Pat. No. 11,038,189, include CeₓZr₁₋ₓO₄ nanofibers as antioxidants in the membrane assemblies. Still other references suggest adding antioxidant compounds into the anode or cathode layers, which would help prevent migration of harmful radicals through the ion exchange membrane. However, while these compounds improve chemical stability, they have not demonstrated the required stability and durability suitable for heavy duty applications, such as for heavy duty trucks, that may run for at least 5,000 hours of service.

### BRIEF SUMMARY OF THE INVENTION

The compositions and products of this invention result in a much stronger resistance to chemical attack, which enables high projected lifetimes for applications like heavy duty trucks. The use of specific CeₓM₁₋ₓO_{y} compounds, such as CeₓM₁₋ₓO_{y} nanoparticles, enables this performance.

In one embodiment, the present invention relates to an ion exchange membrane comprising about 70-99.99% by weight of a fluorinated ionomer, about 0.01-1.0% by weight of a CeₓM₁₋ₓO_{y} nanoparticle, and about 0-29.99% by weight of optional additives, all based on the total dry weight of the membrane; where x is 0.6-0.9, y is 1-3, and M is selected from Zr, Gd, Pr, Eu, Nd, La, Hf, Tb, Pd, Pt, or Ni.

The present invention further relates to an ion exchange dispersion comprising a liquid carrier, about 70-99.99% by weight of a fluorinated ionomer, about 0.01-1.0% by weight of a CeₓM₁₋ₓO_{y} nanoparticle, and about 0-29.99% of optional additives, all based on the total solids weight of the dispersion; where x is 0.6-0.9, y is 1-3, and M is selected from Zr, Gd, Pr, Eu, Nd, La, Hf, Tb, Pd, Pt, or Ni.

In another embodiment, the invention relates to an ion exchange membrane comprising about 70-97.99% by weight of a fluorinated ionomer, about 0.01-1.0% by weight of a CeₓM₁₋ₓO_{y} nanoparticle, and about 2-29.99% by weight of additives including a reinforcement layer, all based on the total dry weight of the membrane; where x is 0.2-0.9, y is 1-3, and M is selected from Zr, Gd, Pr, Eu, Nd, La, Hf, Tb, Pd, Pt, or Ni; and where the reinforcement layer is embedded in the ion exchange membrane.

In yet another embodiment, the invention relates to an ion exchange membrane comprising about 70-99.99% by weight of a fluorinated ionomer, about 0.01-1.0% by weight of a CeₓM₁₋ₓO_{y} compound, and about 0-29.99% by weight of optional additives, all based on the total dry weight of the membrane; where x is 0.6-0.9, y is 1-3, and M is selected from Zr, Gd, Pr, Eu, Nd, La, Hf, Tb, Pd, Pt, or Ni; provided if the membrane is unreinforced, the membrane lasts at least 400 hours before degrading below 0.8 V according to the Open Circuit Voltage Accelerated Stress Test; or provided if the membrane is reinforced, the membrane lasts at least 1,500 hours before degrading below 0.8 V according to the Open Circuit Voltage Accelerated Stress Test.

### BRIEF DESCRIPTION OF THE DRAWINGS

FIG. 1 is a cross-section view of a membrane assembly representing one embodiment.

FIG. 2 is a graph showing Open Circuit Voltage (OCV) Accelerated Stress Test (AST) performance of Comparative Example A.

FIG. 3 is a graph showing OCV AST performance of Comparative Example B.

FIG. 4 is a graph showing OCV AST performance of Comparative Example C.

FIG. 5 is a graph showing OCV AST performance of Example 1.

FIG. 6 is a graph showing OCV AST performance of Example 2.

FIG. 7 is a graph showing OCV AST performance of Example 3.

FIG. 8 is a graph showing OCV AST performance of Example 4.

FIG. 9 is a graph showing Combined AST performance of Comparative Example B.

FIG. 10 is a graph showing Combined AST performance of Example 1.

FIG. 11 is a graph showing Combined AST performance of Example 3.

### DETAILED DESCRIPTION OF THE INVENTION

Features of the embodiments of the present invention as described in the Detailed Description of the Invention can be combined in any manner.

In one embodiment, the present invention relates to an ion exchange membrane comprising about 70-99.99% by weight of a fluorinated ionomer, about 0.01-1.0% by weight of a CeₓM₁₋ₓO_{y} nanoparticle, and about 0-29.99% by weight of optional additives, all based on the total dry weight of the membrane; where x is 0.6-0.9, y is 1-3, and M is selected from Zr, Gd, Pr, Eu, Nd, La, Hf, Tb, Pd, Pt, or Ni. In another embodiment, the invention relates to an ion exchange membrane comprising about 70-97.99% by weight of a fluorinated ionomer, about 0.01-1.0% by weight of a CeₓM₁₋ₓO_{y} nanoparticle, and about 2-29.99% by weight of additives including a reinforcement layer, all based on the total dry weight of the membrane; where x is 0.2-0.9, y is 1-3, and M is selected from Zr, Gd, Pr, Eu, Nd, La, Hf, Tb, Pd, Pt, or Ni; and where the reinforcement layer is embedded in the ion exchange membrane. In another embodiment, the invention relates to an ion exchange membrane comprising about 70-99.99% by weight of a fluorinated ionomer, about 0.01-1.0% by weight of a CeₓM₁₋ₓO_{y} compound, and about 0-29.99% by weight of optional additives, all based on the total dry weight of the membrane; where x is 0.6-0.9, y is 1-3, and M is selected from Zr, Gd, Pr, Eu, Nd, La, Hf, Tb, Pd, Pt, or Ni; provided if the membrane is unreinforced, the membrane lasts at least 400 hours before degrading below 0.8 V according to the Open Circuit Voltage Accelerated Stress Test; or provided if the membrane is reinforced, the membrane lasts at least 1,500 hours before degrading below 0.8 V according to the Open Circuit Voltage Accelerated Stress Test.

The CeₓM₁₋ₓO_{y} compound used in the ion exchange membranes or ion exchange dispersions of this invention may be any compound that provides durability and stability performance to the ion exchange polymer and ion exchange membrane. The molar ratio of Ce to M is important for providing such durability and stability. In one aspect, the molar amount of Ce is greater than the molar amount of M, such that x>(1−x) in the chemical formula CeₓM₁₋ₓO_{y}. In one aspect, x is 0.2-0.9, giving compounds Ce_{0.2-0.9}M_{0.8-0.1}O_{y}; alternatively, x is 0.6-0.9, giving compounds Ce_{0.6-0.9}. M_{0.4-0.1}O_{y}; alternatively, x is 0.7-0.9, giving compounds Ce_{0.7-0.9}M_{0.3-0.1}O_{y}; alternatively, x is 0.75-0.85, giving compounds Ce_{0.75-0.85}M_{0.25-0.15}O_{y}. As for oxygen, y is typically 1-3; alternatively 2-3; alternatively 2.

In the compound CeₓM₁₋ₓO_{y}, M may be any element that facilitates surface oxygen vacancy and/or surface Ce³⁺ ions in the lattice structure of CeO₂. For example, M may be an element selected from Zr, Gd, Pr, Eu, Nd, La, Hf, Tb, Pd, Pt, or Ni. The compound may have multiple M elements present, provided the ratio of Ce to the total of M remains the same. Blends of compounds using different elements M may also be included. In one aspect, M is Zr.

The CeₓM₁₋ₓO_{y} compound may be in any form, including but not limited to the form of a particle or nanoparticle. The compound may typically have an average particle size, as measured by transmission electron microscopy (TEM), of about 1-25 nm; alternatively about 1-20 nm; alternatively about 1-15 nm; alternatively about 5-10 nm; or any range of particles sizes within the cited ranges. The aspect ratio of the compound, as measured by TEM, may typically be 1:1 or greater; alternatively 1:1 to 1:10; alternatively 1:1 to 1:3; or any range of aspect ratios within the cited ranges.

The fluorinated ionomer used in the ion exchange membranes or ion exchange dispersions of this invention may be any ionomer suitable for ion exchange membranes and may comprise one or more different fluorinated ionomers. In one aspect, the fluorinated ionomer is a fluorinated polymer containing sulfonate groups. The term “sulfonate groups” is intended to refer to either sulfonic acid groups or salts of sulfonic acid, including but not limited to alkali metal or ammonium salts. Preferred functional groups are represented by the formula —SO₃X wherein X is H, Li, Na, K or N(R¹)(R²)(R³)(R⁴) where R¹, R², R³, and R⁴ are the same or different and are H, CH₃ or C₂H₅. Fluorinated ionomers containing sulfonate groups are available under the trade name Nafion™ from The Chemours Company (Wilmington, DE).

For example, the fluorinated ionomer may contain the repeat unit:

—[CF₂—CF((CF₂)_{b}—(O—(CF₂CFR_{f})_{c})ₐ—O—(CF₂CFR′_{f})_{d}SO₃X)]—
where b is 0 or 1; c is an integer from 2 to 8; a is 0, 1, or 2; d is an integer from 1 to 8; R_{f} and R′_{f} are independently selected from F, Cl or a perfluorinated alkyl group having 1 to 10 carbon atoms; a=0, 1 or 2; and X is H, Li, Na, K or N(R¹)(R²)(R³)(R⁴) where R¹, R², R³, and R⁴ are the same or different and are H, CH₃ or C₂H₅. For clarity, it is noted that the segment ((CF₂)_{b}—(O—(CF₂CFR_{f})_{c})ₐ—O—(CF₂CFR′f)_{d}SO₃X) in the structure above is the pendant chain from the perfluorinated polymer backbone. Branched pendant chains having multiple sulfonic acid groups are also encompassed.

In one aspect, the fluorinated ionomer is a copolymer made from two or more monomers. For example, it is a copolymer of a sulfonic acid-containing monomer with tetrafluoroethylene (TFE), resulting in a repeat unit—[CF₂—CF₂]—, or with other comonomers. For example, monomers having pendant phosphonic acid groups may also be incorporated into the fluorinated ionomer to yield a fluorinated ionomer containing both sulfonic acid groups and phosphonic acid groups. The fluorinated ionomer, and resulting ion exchange membrane, typically have an equivalent weight (EW) less than about 1000 g/mol; alternatively less than about 900 g/mol; alternatively less than about 850 g/mol; alternatively about 400-1000 g/mol; alternatively about 400-900 g/mol; alternatively about 400-850 g/mol. EW can be measured by acid-base titration, and the units g/mol refer to the amount of fluorinated ionomer in grams needed to neutralize 1 mol of NaOH, indicating 1 mol of sulfonic acid groups.

A class of preferred fluorinated ionomers containing sulfonate groups include a highly fluorinated, most preferably perfluorinated, carbon backbone having pendant chains represented by the formula —(O—CF₂CFR_{f})ₐ—O—CF₂CFR′_{f}SO₃X, where R_{f} and R′_{f} are independently selected from F, Cl or a perfluorinated alkyl group having 1 to 10 carbon atoms; a=0, 1 or 2; and X is H, Li, Na, K or N(R¹)(R²)(R³)(R⁴) where R¹, R², R³, and R⁴ are the same or different and are H, CH₃ or C₂H₅. Preferred fluorinated ionomers containing sulfonate groups may include, for example, polymers disclosed in U.S. Pat. No. 3,282,875; in U.S. Pat. No. 4,358,545; or in U.S. Pat. No. 4,940,525. For vanadium redox flow battery, water electrolysis, and fuel cell applications, fluorinated ionomer in the ion exchange membrane is typically employed in the proton form, i.e., X is H.

One preferred fluorinated ionomer containing sulfonate groups includes a perfluorocarbon backbone and a pendant chain represented by the formula —O—CF₂CF(CF₃)—O—CF₂CF₂SO₃X, where X is as defined above. When X is H, the side chain is —O—CF₂CF(CF₃)—O—CF₂CF₂SO₃H. Fluorinated ionomers containing sulfonate groups of this type are disclosed in U.S. Pat. No. 3,282,875 and may be made by copolymerization of TFE and the perfluorinated vinyl ether CF₂═CF—O—CF₂CF(CF₃)—O—CF₂CF₂SO₂F, perfluoro(3,6-dioxa4-methyl-7-octenesulfonyl fluoride) (PSEPVE), followed by conversion to sulfonate groups by hydrolysis of the sulfonyl fluoride groups and conversion to the proton form if desired for the particular application.

One preferred fluorinated ionomer containing sulfonate groups of the type disclosed in U.S. Pat. Nos. 4,358,545 and 4,940,525 has the pendant chain—O—CF₂CF₂SO₃X, where X is as defined above. This fluorinated ionomer containing sulfonate groups may be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (PFSVE), followed by hydrolysis and conversion to the proton form if desired for the particular application. When X is H, the pendant chain is —O—CF₂CF₂SO₃H.

The ion exchange membrane or ion exchange dispersion may also contain optional additives, including but not limited to reinforcement materials, fillers, surfactants, dispersing aids, or other materials. In one aspect, the ion exchange membrane does not contain catalyst material, such as a metal. In one embodiment, a reinforcement layer is embedded in the ion exchange membrane. In this case, the reinforcement layer may be, for example, polytetrafluoroethylene (PTFE), tetrafluoroethylene-perfluoroalkyl vinyl ether copolymers, polyether ether ketone (PEEK), polyphenylene sulfide (PPS), polyether sulfone (PES), or liquid crystal polymers (LCP). The reinforcement layer may be in the form of a porous support layer, such as a woven fabric, stretched or expanded film, or web. The term “polytetrafluoroethylene” refers to the chemical makeup of the layer and can include woven PTFE, stretched PTFE or expanded PTFE (ePTFE), nonwoven PTFE, etc. When present, the reinforcement layer may compose about 2-29.99% by weight, based on the total dry weight of the ion exchange membrane; alternatively, about 5-24.90% by weight; alternatively about 10-19.90% by weight; or any range of % by weight within the cited ranges. The balance of the optional additive amount, in % by weight of total dry weight thickness, is made up of other types of additives. The reinforcement layer may have a thickness of about 1-100 μm, as measured by contact micrometer; alternatively about 2-75 μm; alternatively about 3-60 μm; or any range of thicknesses within the cited ranges.

The ion exchange membranes are formed by, for example, casting a dispersion of ion exchange polymer. An ion exchange dispersion may be cast onto a substrate, dried, and annealed to form a dry membrane before peeling the dry membrane from the substrate. When reinforcement layers are used, the reinforcement material may be coated, immersed, or otherwise embedded into the ion exchange dispersion before applying the product onto a substrate, drying the product, annealing the product, and peeling the product from the substrate to form a dried reinforced membrane. Other methods of coating the reinforcement layer include but are not limited to brushing, spraying, notch bar coating, fluid die coating, rod coating, slot-fed knife coating, three-roll coating, or decal transfer.

In one aspect, the present invention relates to an ion exchange dispersion comprising a liquid carrier, fluorinated ionomer, CeₓM₁₋ₓO_{y} compound or nanoparticle, and optional additives; where x is 0.6-0.9, y is 1-3, and M is selected from Zr, Gd, Pr, Eu, Nd, La, Hf, Tb, Pd, Pt, or Ni. The fluorinated ionomer, CeₓM₁₋ₓO_{y} compound, and optional additives are described above. The liquid carrier may include water, organic solvents, or mixtures thereof. Examples of suitable organic solvents include, but are not limited to, lower alcohols (such as methanol, ethanol, isopropanol, n-propanol); polyols (such as ethylene glycol, propylene glycol, glycerol); ethers (such as tetrahydrofuran and dioxane); diglyme; polyglycol ethers; ether acetates; acetonitrile; acetone; dimethylsulfoxide; N,N-dimethylacetamide; ethylene carbonate; propylene carbonate; dimethylcarbonate; diethylcarbonate; N,N-dimethylformamide; N-methylpyrrolidinone; dimethylimidazolidinone; butyrolactone; hexamethylphosphoric triamide; isobutyl methyl ketone; sulfolane; and combinations thereof. The solids content of the dispersion may range from about 5-40% by weight; alternatively about 10-35% by weight; alternatively about 15-30% by weight. When mixed with an organic solvent, water typically composes about 15-90% by weight of the total liquid carrier weight, with the balance made up of organic solvent; alternatively, about 20-70% by weight; alternatively, about 25-50% by weight.

The fluorinated ionomer composes about 70-99.99% by weight of the ion exchange membrane or ion exchange dispersion, based on the total dry weight of the membrane or based on the total solids weight of the dispersion; alternatively, about 70-97.99% by weight; alternatively, about 75-99.90% by weight; alternatively, about 75-94.90% by weight; alternatively, about 80-99.90% by weight; alternatively, about 80-89.90% by weight; or any range of weight % within the cited ranges. The CeₓM₁₋ₓO_{y} compound or nanoparticle composes about 0.01-1.0% by weight of the ion exchange membrane or ion exchange dispersion, based on the total dry weight of the membrane or based on the total solids weight of the dispersion; alternatively, about 0.1-1.0% by weight; alternatively, about 0.1-0.5% by weight; or any range of weight % within the cited ranges. The optional additives compose about 0-29.99% by weight of the ion exchange membrane or ion exchange dispersion, inclusive of 0, based on the total dry weight of the membrane or based on the total solids weight of the dispersion; alternatively, about 0-24.90% by weight; alternatively, about 2-29.99% by weight; alternatively, about 5-24.90% by weight; alternatively, about 0-19.90% by weight; alternatively, about 10-19.90% by weight; or any range of weight % within the cited ranges.

The dry thickness of the ion exchange membrane depends on the needs of the end-use application. For example, for fuel cell applications, the ion exchange membranes may have a dry thickness of less than about 20 μm, as measured by Mitutoyo thickness gauge; alternatively, less than about 18 μm; alternatively, about 8-18 μm; alternatively, about 10-15 μm. For water electrolyzer applications, the ion exchange membranes may have a dry thickness of less than about 40-120 μm, as measured by Mitutoyo thickness gauge; alternatively, about 50-95 μm; alternatively, about 45-85 μm.

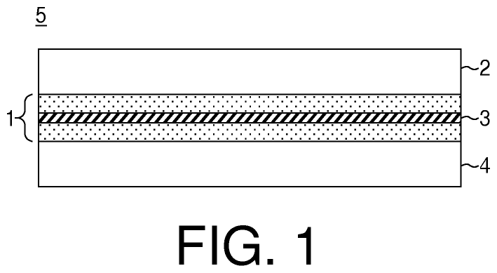

The ion exchange membranes are used in membrane assemblies, having multiple layers of functional materials. A membrane assembly, or membrane electrode assembly (MEA), may comprise a cathode catalyst layer (CCL) on one side of the ion exchange membrane and an anode catalyst layer (ACL) on another side of the ion exchange membrane. For example, in one embodiment shown in FIG. 1, a cathode catalyst layer 4 is in direct contact with an ion exchange membrane 1, and the ion exchange membrane 1 is in further direct contact with anode catalyst layer 2 to make ion exchange membrane assembly 5. The ion exchange membrane 1 may have a reinforcement layer 3 embedded within the ion exchange membrane. The membrane assembly may contain multiple layers of the same material, and it may contain additional layers of functional materials, such as gas diffusion layers or bipolar plates.

The CCL and ACL may be applied to the ion exchange membrane in the form of a catalyst ink. Catalyst ink compositions often include a catalyst component and a polymer binder, where the polymer binder often includes fluorinated ionomers such as those described above. The polymer used in the CCL and ACL may be the same or different from the polymer used as the fluorinated ionomer of the ion exchange membrane. Catalyst components may include but are not limited to metal particles or carbon-supported metal particles. Specific metals may include but are not limited to platinum, ruthenium, gold, silver, palladium, iridium, rhodium, iron, cobalt, nickel, chromium, tungsten, manganese, vanadium, and alloys thereof. Solvents, such as those mentioned for use in the ion exchange dispersion, may be used to aid in application of the catalyst ink to the ion exchange membrane. The CCL and ACL materials may be applied to the ion exchange membrane by any suitable means, including brushing, spraying, notch bar coating, fluid die coating, rod coating, slot-fed knife coating, three-roll coating, or decal transfer.

In one aspect, the ion exchange membrane is unreinforced and lasts at least 400 hours before degrading below 0.8 V according to the Open Circuit Voltage Accelerated Stress Test (Fuel Cell Technical Team Roadmap, November 2017, Table P.3); in another aspect, the ion exchange membrane is unreinforced and lasts at least 500 hours; in another aspect, the ion exchange membrane is unreinforced and lasts at least 800 hours; and in another aspect, the ion exchange membrane is unreinforced and lasts at least 1000 hours. In one aspect, the ion exchange membrane is reinforced and lasts at least 1,500 hours before degrading below 0.8 V according to the Open Circuit Voltage Accelerated Stress Test (Fuel Cell Technical Team Roadmap, November 2017, Table P.3); in another aspect, the ion exchange membrane is reinforced and lasts at least 1,800 hours; in another aspect, the ion exchange membrane or membrane electrode assembly is reinforced and lasts at least 2,000 hours; and in another aspect, the ion exchange membrane is reinforced and lasts at least 2,300 hours. In one aspect, the ion exchange membrane is reinforced and lasts at least 60,000 combined cycles before the hydrogen crossover exceeds 15 mA/cm² according to the Combined AST (Fuel Cell Technical Team Roadmap, November 2017, Table P.5); in another aspect, the ion exchange membrane is reinforced and lasts at least 75,000 combined cycles before the hydrogen crossover exceeds 15 mA/cm²; and in another aspect, the ion exchange membrane is reinforced and lasts at least 100,000 combined cycles before the hydrogen crossover exceeds 15 mA/cm².

### EXAMPLES

The invention is illustrated in the following examples which do not limit the scope of the invention as described in the claims.

All solvents and reagents, unless otherwise indicated, are available from Sigma-Aldrich, St. Louis, MO.

W813 is a dispersion of Ce_{0.82}Zr_{0.18}O₂ having a solids content of 13% by weight, where the Ce_{0.82}Zr_{0.18}O₂ has an average particle size of 5 nm; Ce_{0.75}Zr_{0.25}O₂ Dispersion is a dispersion of Ce_{0.75}Zr_{0.25}O₂ having a solids content of 19.2% by weight, where the Ce_{0.75}Zr_{0.25}O₂ has an average particle size <25 nm; CeO₂ Dispersion 1 is a dispersion having a solids content of 9.5% by weight, where the CeO₂ has an average particle size of 25 nm; and CeO₂ Dispersion 2 is a dispersion having a solids content of 20% by weight, where the CeO₂ has an average particle size of 5 nm; all available from Cerion Nanomaterials, Rochester, NY.

Nafion™ D2020 is a perfluorosulfonic acid polymer dispersion having a solids content of 20-22% by weight and an EW of about 920, available from The Chemours Company, Wilmington, DE.

The expanded PTFE reinforcement layer was a nonwoven fabric having a thickness of 8 μm, available from Donaldson Company, Inc., Minneapolis, MN.

Platinum on carbon black electrocatalyst (46.3% Pt) is available from Tanaka Kikinkzoku Koygo K. K. (Marunouchi, Japan).

### Test Methods

The following test methods and materials were used in the examples herein.

### Membrane Assembly Preparation

Platinum on carbon black electrocatalyst (510.5 mg), deionized water (68.00 g), n-propanol (41.76 g), and Nafion™ D2020 dispersion (1194 μL) were stirred together to form a catalyst ink solution, then cooled on ice for 30 minutes. The catalyst ink was sonicated by horn sonicator at 50% power for 10 seconds, followed by bath sonication in cold water (0-5° C.) for 30 minutes.

The catalyst ink was sprayed onto both sides of the ion exchange membranes by ultrasonic spray coating at 90° C. with vacuum on (Sonotek ExactaCoat). The membranes have a final loading of 0.1 mg Pt/cm² on the anode side and 0.4 mg Pt/cm² on the cathode side.

### Test Method 1—Open Circuit Voltage (OCV) Accelerated Stress Test (AST)

This test measures chemical stability and is a test standard prescribed by the U.S. Department of Energy's Fuel Cell Technical Team recommendations (Fuel Cell Technical Team Roadmap, November 2017, Table P.3), known as the OCV AST. Membrane assemblies were tested according to this standard test method, except the conditions were repeated for the amount of time shown rather than the standard 500 hours. The test was conducted until the cell voltage degraded below 0.8 V.

### Test Method 2—Combined AST

This test measures combined chemical and mechanical stability and is a test standard prescribed by the U.S. Department of Energy's Fuel Cell Technical Team recommendations (Fuel Cell Technical Team Roadmap, November 2017, Table P.5), known as the Combined AST. Membrane assemblies were tested according to this standard test method, where the conditions were repeated until the hydrogen crossover exceeded 15 mA/cm².

### Comparative Example A

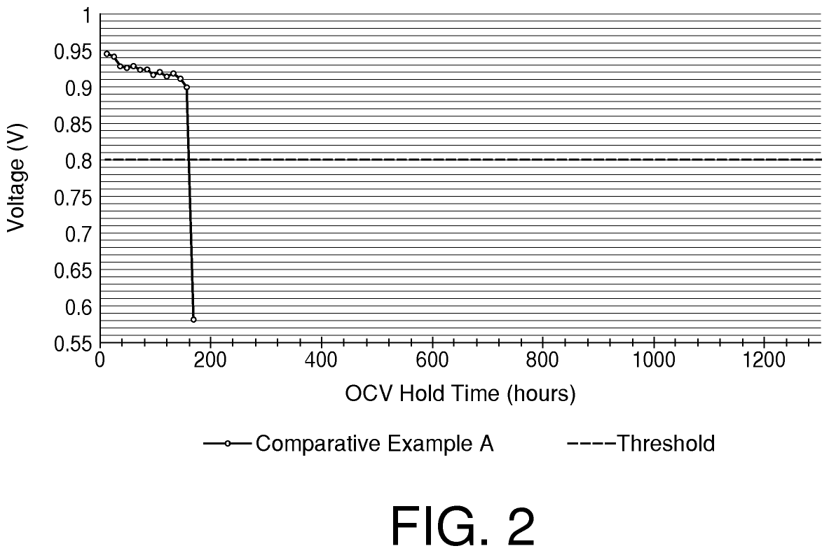

Nafion™ D2020 dispersion (15.0 g) was added to a 20-mL glass vial equipped with a stir bar and placed on a stir plate at medium rotation. To the agitated dispersion was added CeO₂ Dispersion 1 (124.1 mg) until the CeO₂ was fully incorporated, forming a milky liquid composite dispersion. The dispersion was cast onto a polyethylene terephthalate (PET) substrate affixed to a glass plate and coated with a doctor blade to a wet thickness of 200 μm. The dispersion layer was allowed to dry for 1 hour at 10% relative humidity in a dry box to form a dry membrane having a thickness of 17 μm across the membrane. The dry membrane was then heated at 160° C. for 3 minutes in a convection oven to thermally set the polymer. After removal from the oven, the membrane was peeled from the PET substrate to give a stand-alone film. A membrane assembly was formed and tested according to the Test Methods above. Results are shown in FIG. 2. The cell voltage degraded below 0.8 V at 166 hrs.

### Comparative Example B

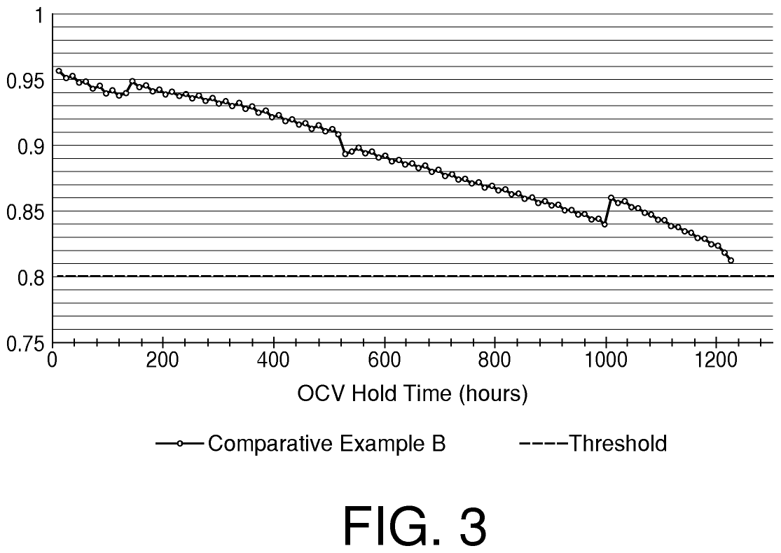

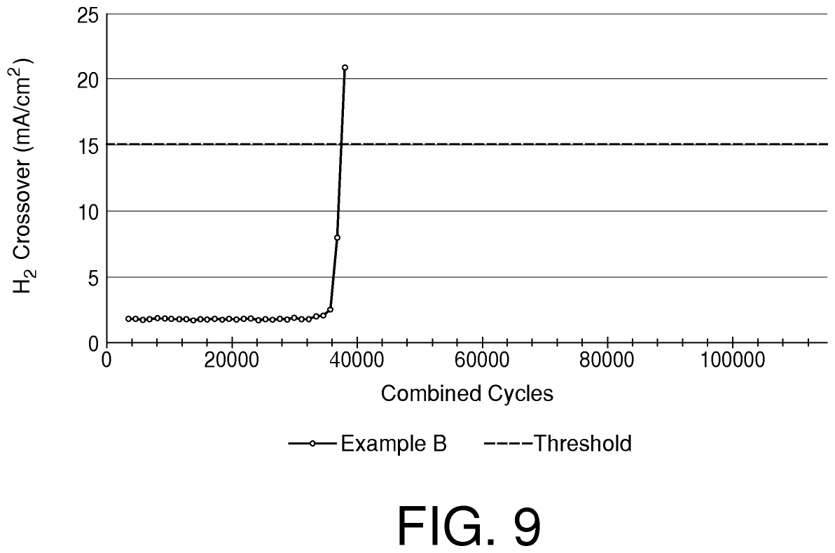

Comparative Example A was repeated to form the membrane dispersion, at a larger scale. To the Nafion™ D2020 dispersion was added approximately 0.4% CeO₂ Dispersion 1 by mass. The resulting mixture was then diluted to 16% solids while maintaining the same ratio of 1.29 parts n-propanol to 1 part water by mass. The resulting composite dispersion was embedded with an expanded PTFE reinforcement layer using a roll-to-roll slot die membrane coater. This process resulted in a wet intermediate of approximately 150 microns thickness. The wet intermediate was then dried by sequential heating to a series of increasing drying temperatures, the first of these temperatures being between 12° and 150° F. and the last of these temperatures being between 14° and 160° F. The dry intermediate membrane was then thermally set by a subsequent heating step, the temperature of which was between 32° and 340° F. The dry, thermally-set membrane was lastly subjected to a final heating step, the temperature of which was between 11° and 130° F. The dry thickness of the membrane was 15 μm. A membrane assembly was formed and tested according to the Test Methods above. Results are shown in FIG. 3 and FIG. 9. The cell voltage degraded to 0.802 V at 1,235 hours. The hydrogen crossover exceeded 15 mA/cm² at 38,016 cycles.

### Comparative Example C

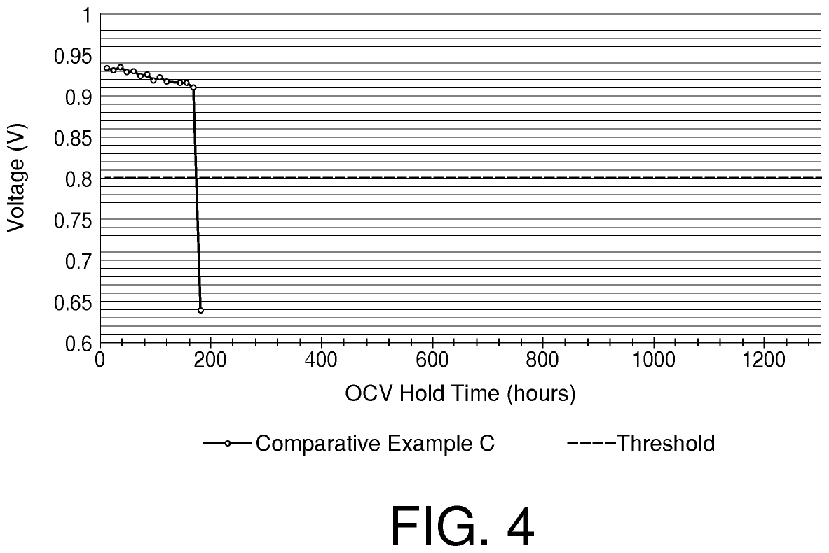

Comparative Example A was repeated, using CeO₂ Dispersion 2 instead of CeO₂ Dispersion 1. In this example, the agitated Nafion™ D2020 dispersion (15.0 g) was combined with CeO₂ Dispersion 2 (58.9 mg), and the dry thickness of the membrane was 20 μm. A membrane assembly was formed and tested according to the Test Methods above. Results are shown in FIG. 4. The cell voltage degraded below 0.8 V at 180 hours.

### Example 1

A dispersion of a copolymer of TFE and perfluoro(4-methyl-3,6-dioxa-7-octene-1-sulfonic acid) was formed by the procedures of U.S. Pat. No. 4,433,082. The final polymer dispersion contained 27.5% by weight ion exchange polymer, 27.6% by weight water, and 44.9% by weight ethanol, with an EW value of 814.

Separately, water and ethanol were combined in a vessel equipped with stirring. A dispersion of W813 was slowly added to the mixture to form a Ce_{0.82}Zr_{0.18}O₂ dispersion having a weight ratio of W813 dispersion/water/ethanol of 1/2/2. The resulting Ce_{0.82}Zr_{0.18}O₂ mixture (234.28 g) was mixed with the fluorinated ion exchange polymer dispersion (3 kg) under high mixing to form a composite dispersion. The composite dispersion was embedded with an expanded PTFE reinforcement layer using a roll-to-roll slot die membrane coater. This resulted in a wet intermediate of approximately 130 microns thickness. The resulting wet intermediate was then dried by sequential heating to a series of increasing drying temperatures, the first of these temperatures being between 4° and 70° C. and the last of these temperatures being between 14° and 170° C. The dry intermediate membrane was then thermally set by a final heating step, the temperature of which was between 18° and 200° C. The dry thickness of the membrane was 15 μm.

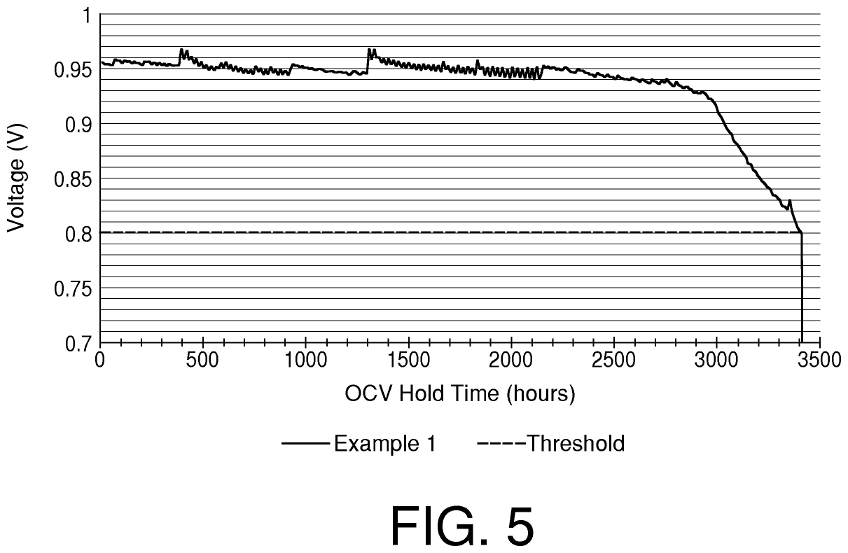

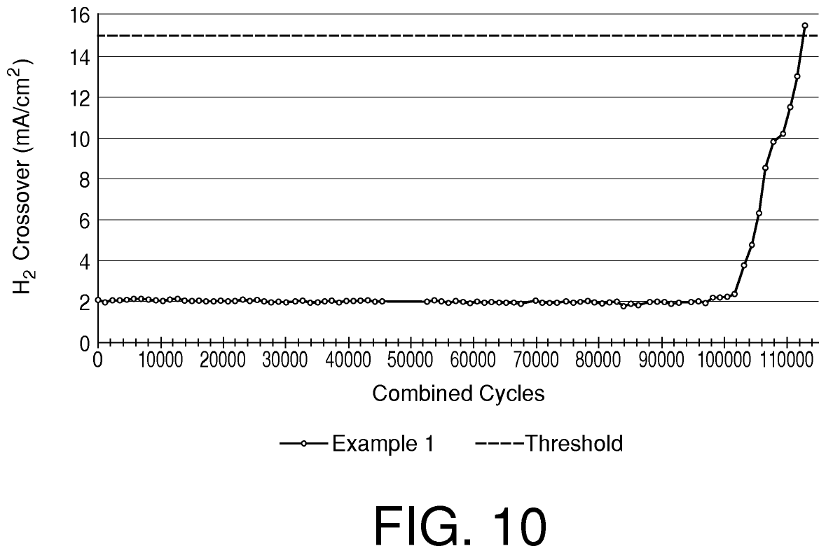

A membrane assembly was formed and tested according to the Test Methods above. Results are shown in FIG. 5 and FIG. 10. The cell voltage degraded below 0.8 V at 3,346 hours, and the hydrogen crossover exceeded 15 mA/cm² at 112,878 cycles. When compared against Comparative Examples B and C, it can be seen that the membrane containing Ce_{0.82}Zr_{0.18}O₂ has unexpectedly superior durability over similar reinforced membranes containing CeO₂.

### Example 2

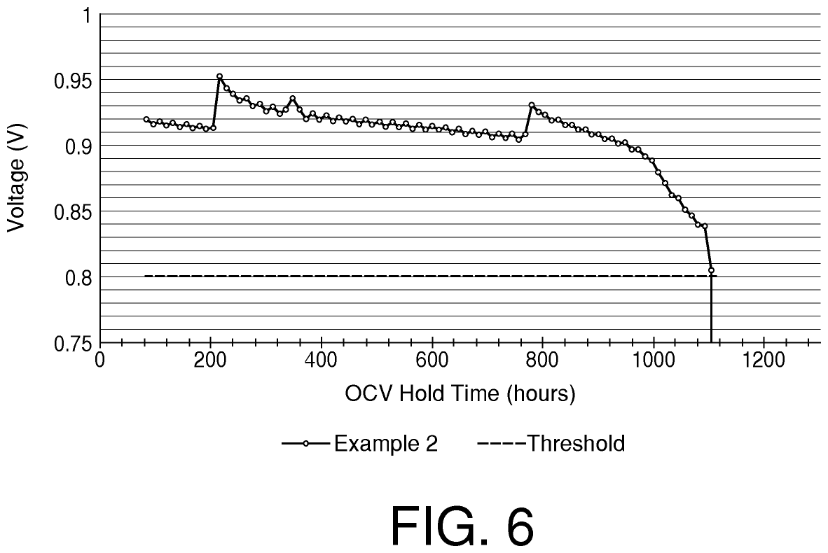

Example 1 was repeated at a smaller scale, using Nafion™ D2020 dispersion as the polymer dispersion. The composite dispersion contained 15.0 g of Nafion™ D2020 dispersion and 155.6 mg of the Ce_{0.82}Zr_{0.18}O₂ mixture. The composite dispersion was cast onto a polyethylene terephthalate (PET) substrate affixed to a glass plate and coated with a doctor blade to a wet thickness of 200 μm. The dispersion layer was allowed to dry for 1 hour at 10% relative humidity in a dry box to form a dry membrane having a thickness of 18 μm across the membrane. The dry membrane was then heated at 160° C. for 3 minutes in a convection oven to thermally set the polymer. After removal from the oven, the membrane was peeled from the PET substrate to give a stand-alone film of dry thickness 18 μm. A membrane assembly was formed and tested according to the Test Methods above. Results are shown in FIG. 6. The cell voltage degraded below 0.8 V at 1,108 hours. When compared against Comparative Example A, it can be seen that the membrane containing Ce_{0.82}Zr_{0.18}O₂ lasts about 6× longer than a similar unreinforced membrane containing CeO₂.

### Example 3

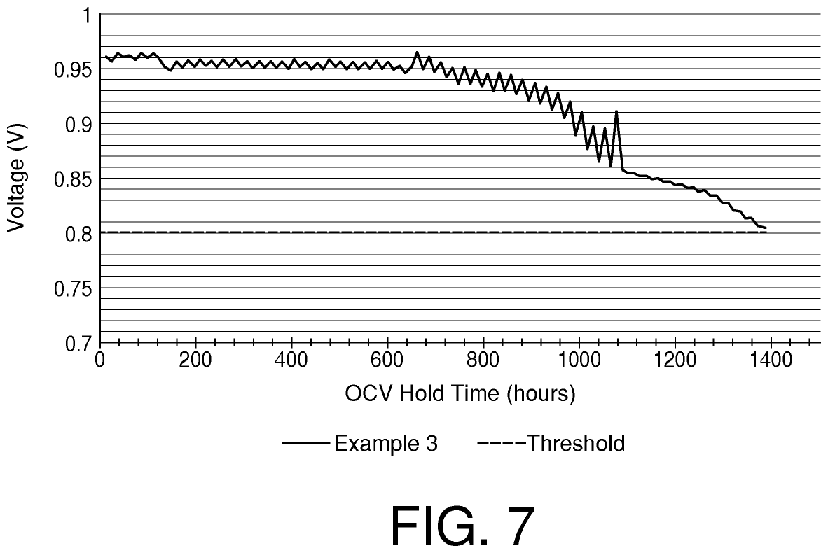

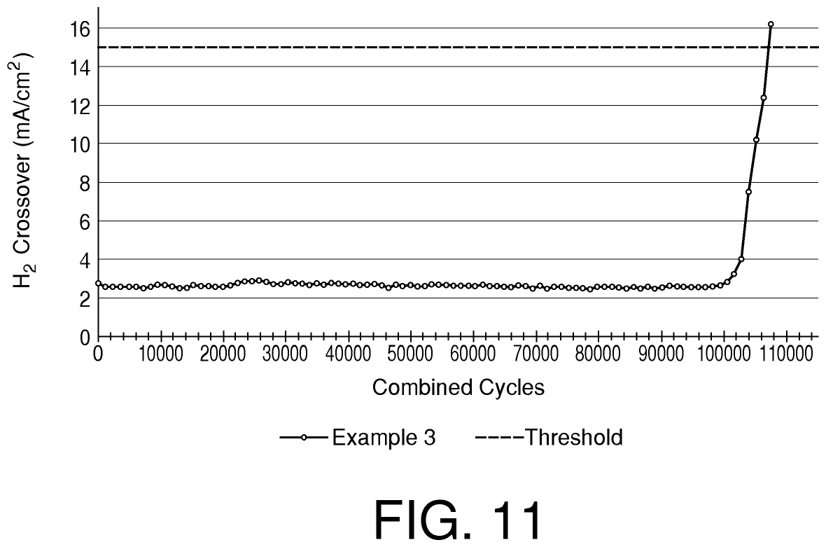

Example 1 was repeated, except the wet thickness was 75 μm and dry membrane thickness was 10 μm. A membrane assembly was formed and tested according to the Test Methods above. Results are shown in FIG. 7 and FIG. 11. The cell voltage degraded to 0.805 V at 1,384 hours. The hydrogen crossover exceeded 15 mA/cm² at 107,550 cycles. Even at a lower membrane thickness, it can be seen that the membrane has superior chemical and mechanical stability compared with membranes using CeO₂ radical scavengers.

### Example 4

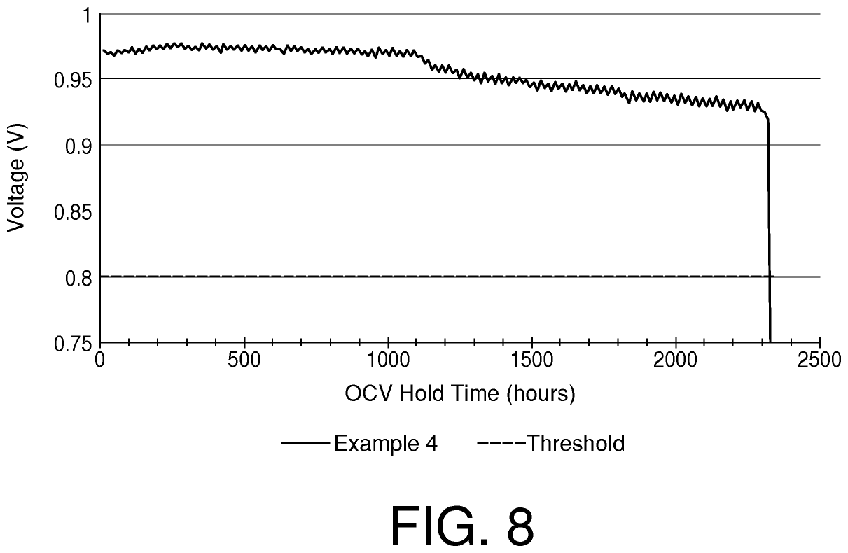

Example 2 was repeated, except the radical scavenger dispersion was Ce_{0.75}Zr_{0.25}O₂ Dispersion. A membrane assembly was formed and tested according to the Test Methods above. Results are shown in FIG. 8. The cell voltage degraded below 0.8 V at 2,330 hours. When compared against Comparative Example A, it can be seen that the membrane containing Ce_{0.75}Zr_{0.25}O₂ lasts about 14× longer than a similar unreinforced membrane containing CeO₂.

1. An ion exchange membrane comprising about 70-99.99% by weight of a fluorinated ionomer, about 0.01-1.0% by weight of a CeₓM₁₋ₓO_{y} nanoparticle, and about 0-29.99% by weight of optional additives, all based on the total dry weight of the membrane; where x is 0.6-0.9, y is 1-3, and M is selected from Zr, Gd, Pr, Eu, Nd, La, Hf, Tb, Pd, Pt, or Ni.

2. The ion exchange membrane of claim 1, where the optional additives are present and comprise a reinforcement layer embedded in the ion exchange membrane.

3. The ion exchange membrane of claim 2, where the reinforcement layer is selected from polytetrafluoroethylene, tetrafluoroethylene-perfluoroalkyl vinyl ether copolymers, polyether ether ketone, polyphenylene sulfide, polyether sulfone, or liquid crystal polymers.

4. The ion exchange membrane of claim 3, where the reinforcement layer is expanded PTFE (ePTFE).

5. The ion exchange membrane of claim 1, where M is Zr.

6. The ion exchange membrane of claim 1, where the CeₓM₁₋ₓO_{y} nanoparticle has an aspect ratio of 1:1 to 1:10.

7. The ion exchange membrane of claim 6, where the CeₓM₁₋ₓO_{y} nanoparticle has an aspect ratio of 1:1 to 1:3.

8. The ion exchange membrane of claim 1, where the average particle size of the CeₓM₁₋ₓO_{y} nanoparticle is about 1-25 nm.

9. The ion exchange membrane of claim 8, where the average particle size of the CeₓM₁₋ₓO_{y} nanoparticle is about 1-15 nm.

10. The ion exchange membrane of claim 1, having an equivalent weight (EW) less than about 1000 g/mol.

11. The ion exchange membrane of claim 10, having an EW less than about 900 g/mol.

12. The ion exchange membrane of claim 1, having a dry thickness less than about 20 μm.

13. The ion exchange membrane of claim 1, having a dry thickness of about 40-120 μm.

14. The ion exchange membrane of claim 1, comprising about 75-99.90% by weight of a fluorinated ionomer, about 0.1-1.0% by weight of a CeₓM₁₋ₓO_{y} nanoparticle, and about 0-24.90% of optional additives, all based on the total dry weight of the membrane.

15. The ion exchange membrane of claim 1, where the fluorinated ionomer is a fluorinated polymer having sulfonate groups.

16. An ion exchange dispersion comprising a liquid carrier, about 70-99.99% by weight of a fluorinated ionomer, about 0.01-1.0% by weight of a CeₓM₁₋ₓO_{y} nanoparticle, and about 0-29.99% of optional additives, all based on the total solids weight of the dispersion; where x is 0.6-0.9, y is 1-3, and M is selected from Zr, Gd, Pr, Eu, Nd, La, Hf, Tb, Pd, Pt, or Ni.

17. The ion exchange dispersion of claim 16, where M is Zr.

18. The ion exchange dispersion of claim 16, where the CeₓM₁₋ₓO_{y} nanoparticle has an aspect ratio of 1:1 to 1:10.

19. The ion exchange dispersion of claim 16, where the average particle size of the CeₓM₁₋ₓO_{y} nanoparticle is about 1-25 nm.

20. The ion exchange dispersion of claim 16, having an equivalent weight (EW) less than about 1000 g/mol.

21. The ion exchange dispersion of claim 16, comprising about 75-99.90% by weight of a fluorinated ionomer, about 0.1-1.0% by weight of a CeₓM₁₋ₓO_{y} nanoparticle, and about 0-24.90% of optional additives, all based on the total solids weight of the dispersion.

22. The ion exchange dispersion of claim 16, where the fluorinated ionomer is a fluorinated polymer having sulfonate groups.

23. A membrane assembly comprising the ion exchange membrane of claim 1, where the membrane assembly comprises a cathode catalyst layer on one side of the ion exchange membrane and an anode catalyst layer on another side of the ion exchange membrane.

24. An ion exchange membrane comprising about 70-97.99% by weight of a fluorinated ionomer, about 0.01-1.0% by weight of a CeₓM₁₋ₓO_{y} nanoparticle, and about 2-29.99% by weight of additives including a reinforcement layer, all based on the total dry weight of the membrane; where x is 0.2-0.9, y is 1-3, and M is selected from Zr, Gd, Pr, Eu, Nd, La, Hf, Tb, Pd, Pt, or Ni; and where the reinforcement layer is embedded in the ion exchange membrane.

25. The ion exchange membrane of claim 24, where the reinforcement layer is selected from polytetrafluoroethylene, tetrafluoroethylene-perfluoroalkyl vinyl ether copolymers, polyether ether ketone, polyphenylene sulfide, polyether sulfone, or liquid crystal polymers.

26. The ion exchange membrane of claim 25, where the reinforcement layer is expanded PTFE (ePTFE).

27. The ion exchange membrane of claim 24, where M is Zr.

28. The ion exchange membrane of claim 24, where the CeₓM₁₋ₓO_{y} nanoparticle has an aspect ratio of 1:1 to 1:10.

29. The ion exchange membrane of claim 28, where the CeₓM₁₋ₓO_{y} nanoparticle has an aspect ratio of 1:1 to 1:3.

30. The ion exchange membrane of claim 24, where the average particle size of the CeₓM₁₋ₓO_{y} nanoparticle is about 1-25 nm.

31. The ion exchange membrane of claim 30, where the average particle size of the CeₓM₁₋ₓO_{y} nanoparticle is about 1-15 nm.

32. The ion exchange membrane of claim 24, having an equivalent weight (EW) less than about 1000 g/mol.

33. The ion exchange membrane of claim 32, having an EW less than about 900 g/mol.

34. The ion exchange membrane of claim 24, having a dry thickness less than about 20 μm.

35. The ion exchange membrane of claim 24, having a dry thickness of about 40-120 μm.

36. The ion exchange membrane of claim 24, comprising about 75-94.90% by weight of a fluorinated ionomer, about 0.1-1.0% by weight of a CeₓM₁₋ₓO_{y} nanoparticle, and about 5-24.90% of optional additives, all based on the total dry weight of the membrane.

37. The ion exchange membrane of claim 24, where the fluorinated ionomer is a fluorinated polymer having sulfonate groups.

38. A membrane assembly comprising the ion exchange membrane of claim 24, where the membrane assembly comprises a cathode catalyst layer on one side of the ion exchange membrane and an anode catalyst layer on another side of the ion exchange membrane.

39. An ion exchange membrane comprising about 70-99.99% by weight of a fluorinated ionomer, about 0.01-1.0% by weight of a CeₓM₁₋ₓO_{y} compound, and about 0-29.99% by weight of optional additives, all based on the total dry weight of the membrane; where x is 0.6-0.9, y is 1-3, and M is selected from Zr, Gd, Pr, Eu, Nd, La, Hf, Tb, Pd, Pt, or Ni; and
provided if the membrane is unreinforced, the membrane lasts at least 400 hours before degrading below 0.8 V according to the Open Circuit Voltage Accelerated Stress Test; or
provided if the membrane is reinforced, the membrane lasts at least 1,500 hours before degrading below 0.8 V according to the Open Circuit Voltage Accelerated Stress Test.

40. The ion exchange membrane of claim 39, where the membrane lasts at least 500 hours before degrading below 0.8 V according to the Open Circuit Voltage Accelerated Stress Test when unreinforced; or the membrane lasts at least 1,800 hours before degrading below 0.8 V according to the Open Circuit Voltage Accelerated Stress Test when reinforced.

41. The ion exchange membrane of claim 39, where the optional additives are present and comprise a reinforcement layer embedded in the ion exchange membrane.

42. The ion exchange membrane of claim 41, comprising about 70-97.99% by weight of a fluorinated ionomer, about 0.01-1.0% by weight of a CeₓM₁₋ₓO_{y} nanoparticle, and about 2-29.99% by weight of additives including a reinforcement layer, all based on the total dry weight of the membrane.

43. The ion exchange membrane of claim 41, where the reinforcement layer is selected from polytetrafluoroethylene, tetrafluoroethylene-perfluoroalkyl vinyl ether copolymers, polyether ether ketone, polyphenylene sulfide, polyether sulfone, or liquid crystal polymers.

44. The ion exchange membrane of claim 43, where the reinforcement layer is expanded PTFE (ePTFE).

45. The ion exchange membrane of claim 39, where M is Zr.

46. The ion exchange membrane of claim 39, where the CeₓM₁₋ₓO_{y} compound has an aspect ratio of 1:1 to 1:10.

47. The ion exchange membrane of claim 46, where the CeₓM₁₋ₓO_{y} compound has an aspect ratio of 1:1 to 1:3.

48. The ion exchange membrane of claim 39, where the average particle size of the CeₓM₁₋ₓO_{y} compound is about 1-25 nm.

49. The ion exchange membrane of claim 48, where the average particle size of the CeₓM₁₋ₓO_{y} compound is about 1-15 nm.

50. The ion exchange membrane of claim 39, having an equivalent weight (EW) less than about 1000 g/mol.

51. The ion exchange membrane of claim 50, having an EW less than about 900 g/mol.

52. The ion exchange membrane of claim 39, having a dry thickness less than about 20 μm.

53. The ion exchange membrane of claim 39, having a dry thickness of about 40-120 μm.

54. The ion exchange membrane of claim 39, comprising about 75-99.90% by weight of a fluorinated ionomer, about 0.1-1.0% by weight of a CeₓM₁₋ₓO_{y} compound, and about 0-24.90% of optional additives, all based on the total dry weight of the membrane.

55. The ion exchange membrane of claim 39, where the fluorinated ionomer is a fluorinated polymer having sulfonate groups.

56. A membrane electrode assembly comprising the ion exchange membrane of claim 39, where the membrane assembly comprises a cathode catalyst layer on one side of the ion exchange membrane and an anode catalyst layer on another side of the ion exchange membrane.
